(19) United States
(12) Patent Application Publication
(10) Pub. No.: US 2017/0177673 A1
(43) Pub. Date: Jun. 22, 2017

(54) GUIDELINES FOR CONTENT PUBLISHING IN A SOCIAL NETWORK

(71) Applicant: International Business Machines Corporation, Armonk, NY (US)

(72) Inventors: Leonid Bolshinsky, Karmiel (IL); Vladimir Gamaley, Rehovot (IL); Sharon Krisher, Haifa (IL)

(21) Appl. No.: 14/977,951

(22) Filed: Dec. 22, 2015

(51) Int. Cl. G06F 17/30; H04L 29/08; H04L 12/58

(52) U.S. Cl. CPC G06F 17/30528; H04L 51/32; H04L 67/1044; H04L 67/306; G06F 17/30554

(57) ABSTRACT

In an approach for providing guidelines to a user for content publishing in a social network, a processor receives initialization of a composition of a post to a first group of a social network. A processor retrieves information from the first group of the social network. A processor analyzes the information. A processor provides a guideline based on the analysis, wherein the guideline includes at least one recommendation as to how to formulate the post.

### BACKGROUND OF THE INVENTION

The present invention relates generally to the field of data analysis, and more particularly to providing guidelines to a user for content publishing in a social network.

Analysis of data is a process of inspecting, cleaning, transforming, and modeling data with the goal of discovering useful information, suggesting conclusions and supporting decision making. Data analysis has multiple facets and approaches, encompassing diverse techniques under a variety of names, in different business, science, and social science domains.

Social media are computer-mediated tools that allow people to create, share, or exchange information, ideas, and pictures/videos in virtual communities and networks. Furthermore, social media depend on mobile and web-based technologies to create highly interactive platforms through which individuals and communities share, co-create, discuss, and modify user-generated content. Social media introduce substantial and pervasive changes to communication between businesses, organizations, communities, and individuals. Social media are different from traditional or industrial media in many ways, including quality, reach, frequency, usability, immediacy, and permanence. Social media operates in a dialogic transmission system (many sources to many receivers). This is in contrast to traditional media that operates under a monologic transmission model (one source to many receivers).

### SUMMARY

Aspects of an embodiment of the present invention disclose a method, computer program product, and computing system for providing guidelines to a user for content publishing in a social network. A processor receives initialization of a composition of a post to a first group of a social network. A processor retrieves information from the first group of the social network. A processor analyzes the information. A processor provides a guideline based on the analysis, wherein the guideline includes at least one recommendation as to how to formulate the post.

### BRIEF DESCRIPTION OF THE DRAWINGS

FIG. 1 depicts a block diagram of a computing system, in accordance with an embodiment of the present invention.

FIG. 2 depicts a flowchart of the steps of a post guideline program, executing within the computing system of FIG. 1, for providing guidelines to a user for content publishing in a social network, in accordance with an embodiment of the present invention.

FIG. 3 depicts a block diagram of components of the servers and/or the computing device of FIG. 1, in accordance with an embodiment of the present invention.

### DETAILED DESCRIPTION

Embodiments of the present invention recognize that when posting a message to a group of connections in a social network (e.g., a community or a group of friends), the way in which a user writes the post can greatly affect how the message is received. When the user posts the message to the group, embodiments of the present invention analyze past posts to identify how the past posts were received. Additionally, embodiments of the present invention provide guidelines to the user for content publishing in the social network.

Embodiments of the present invention will now be described in detail with reference to the Figures.

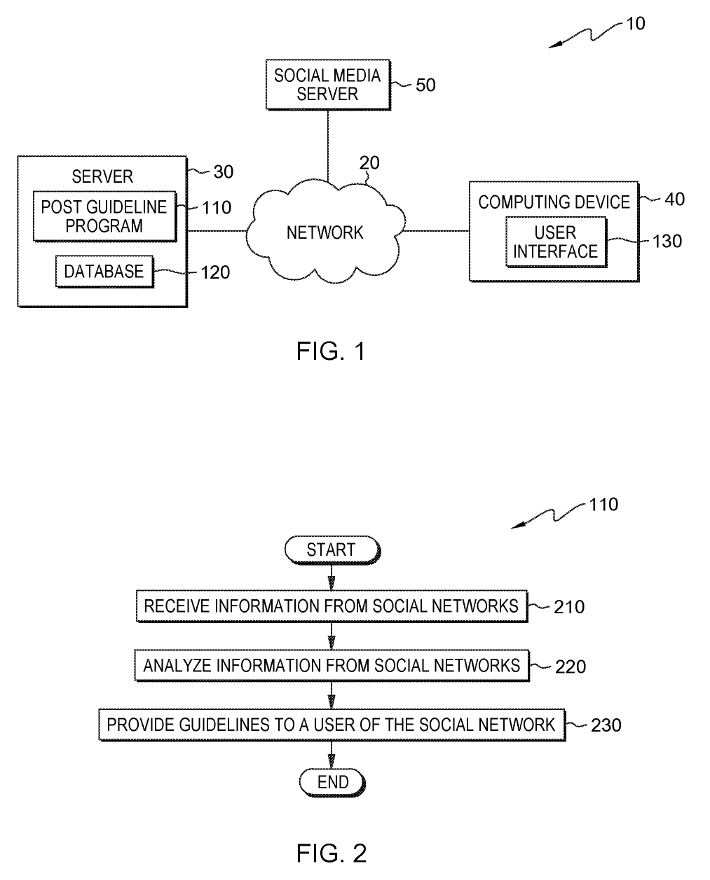

FIG. 1 depicts a block diagram of computing system 10, in accordance with one embodiment of the present invention. FIG. 1 provides an illustration of one embodiment and does not imply any limitations with regard to the environments in which different embodiments may be implemented.

In the depicted embodiment, computing system 10 includes server 30, computing device 40, and social media server 50 interconnected over network 20. Network 20 may be a local area network (LAN), a wide area network (WAN) such as the Internet, a cellular data network, any combination thereof, or any combination of connections and protocols that will support communications between server 30, computing device 40, and social media server 50, in accordance with embodiments of the invention. Network 20 may include wired, wireless, or fiber optic connections. Computing system 10 may include additional computing devices, servers, or other devices not shown.

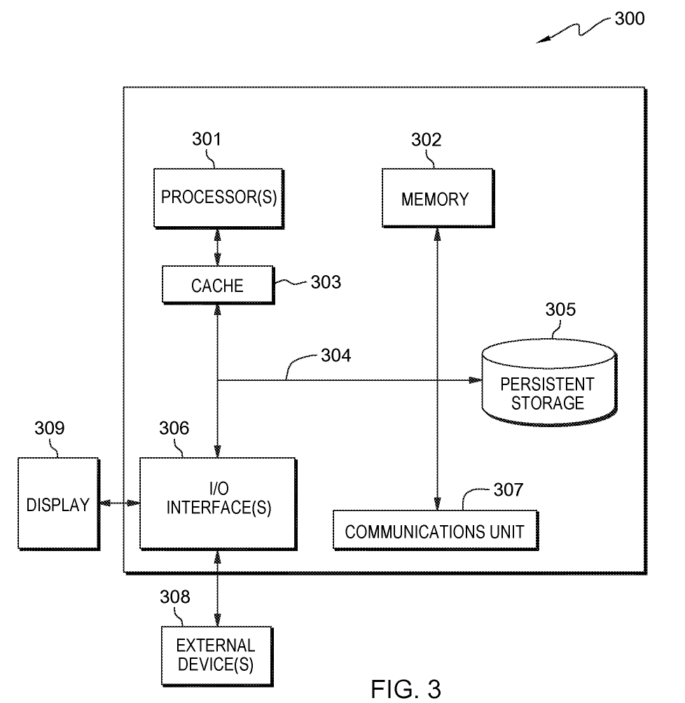

Server 30 may be a management server, a web server, or any other electronic device or computing system capable of processing program instructions and receiving and sending data. In some embodiments, server 30 may be a laptop computer, tablet computer, netbook computer, personal computer (PC), a desktop computer, or any programmable electronic device capable of communicating with computing device 40 and social media server 50 via network 20. In other embodiments, server 30 may represent a server computing system utilizing multiple computers as a server system, such as in a cloud computing environment. In another embodiment, server 30 represents a computing system utilizing clustered computers and components to act as a single pool of seamless resources. In the depicted embodiment, server 30 contains post guideline program 110 and database 120. In other embodiments, server 30 may include post guideline program 110, database 120, and/or other components, as depicted and described in further detail with respect to FIG. 3.

Computing device 40 may be a desktop computer, laptop computer, netbook computer, or tablet computer. In general, computing device 40 may be any electronic device or computing system capable of processing program instructions, sending and receiving data, and communicating with server 30 and social media server 50 via network 20. In the depicted embodiment, computing device 40 contains user interface 130. In other embodiments, computing device 40 may include user interface 130 and/or other components, as depicted and described in further detail with respect to FIG. 3.

Social media server 50 may be a management server, a web server, or any other electronic device or computing system capable of processing program instructions and receiving and sending data. In some embodiments, social media server 50 may be a laptop computer, tablet computer, netbook computer, personal computer (PC), a desktop computer, or any programmable electronic device capable of communicating with server 30 and computing device 40 via network 20. In other embodiments, social media sever 50 may represent a server computing system utilizing multiple computers as a server system, such as in a cloud computing environment. In another embodiment, social media sever 50 represents a computing system utilizing clustered computers and components to act as a single pool of seamless resources. In some embodiments, social media server 50 contains information, such as, for example, user posts from various social media websites. In other embodiments, social media server 50 may include multiple components, as depicted and described in further detail with respect to FIG. 3.

Additionally, social media server 50 may host a social networking platform, professional networking platform, email service, or contact list capable of providing contact information or other information about a “friend,” or other social networking connection. In one embodiment, social media server 50 may be a server for a social networking company that provides social network users with an ability to establish connections with other users of the same social network. Connected users may be able to view contact, interest, relationship, employment, or other information that is shared with the user by each respective connection.

User interface 130 may be any user interface used to access information from server 30 and social media server 50, such as information gathered and/or produced by post guideline program 110. In some embodiments, user interface 130 may be a generic web browser used to retrieve, present, and negotiate information resources from the Internet. In other embodiments, user interface 130 may be a software program or application that enables a user at computing device 40 to access server 30 and social media server 50 over network 20. In the depicted embodiment, user interface 130 resides on computing device 40. In other embodiments, user interface 130, or similar user interfaces, may reside on another computing device, another server, or server 30, provided that user interface 130 is accessible to post guideline program 110.

Post guideline program 110 provides guidelines to a user for content publishing in a social network. In doing so, post guideline program 110 receives information from social networks. Post guideline program 110 analyzes information from social networks. Post guideline program 110 provides guidelines to a user of the social network. In the depicted embodiment, post guideline program 110 resides on server 30. In other embodiments, post guideline program 110 may reside on another server, computing device, or computing device 40, provided that post guideline program 110 can access database 120 and user interface 130.

Database 120 may be a repository that may be written to and/or read by post guideline program 110. In some embodiments, post guideline program 110 may allow a user to define various properties of a social network post to analyze and store the various properties of the social network post to database 120. In other embodiments, database 120 may store properties of a social network post that were previously analyzed. In the depicted embodiment, database 120 resides on server 30. In other embodiments, database 120 may reside on another server, computing device, or computing device 40, provided that database 120 is accessible to post guideline program 110.

FIG. 2, depicts a flowchart of the steps of a post guideline program, executing within the computing system of FIG. 1, in accordance with an embodiment of the present invention.

Post guideline program 110 provides guidelines to a user for content publishing in a social network.

Initially, post guideline program 110 is triggered when a user initiates a composition of a post to a community or group within a social network. In one example, post guideline program 110 may be triggered when the user clicks on the “post a comment” box within user interface 130. In another example, post guideline program 110 may be triggered when the user begins to compose the post.

In step 210, post guideline program 110 receives information from social networks. In some embodiments, the information received from social networks may be posts and information from a particular community or group within a social network. In one embodiment, post guideline program 110 receives information by retrieving previously stored information from database 120. In other embodiments, post guideline program 110 monitors social media networks, such as from social media server 50. In some embodiments, for example, information may be gathered from social media profiles for the users, recent searches on general or internal search engines, social media posts, etc.

In step 220, post guideline program 110 analyzes the information from the social networks. In some embodiments, the analysis is performed by using an approach for the calculation of the popularity of a post within a community or group in the social network. In some embodiments, the approach is an aggregation of the positive actions the post caused to the community of affected users. In one example, the popularity of a post “p” is defined as popularity(p)=0.4*num_likes+0.4*num_of_sharings+0.2*num_non_negative_comments. For clarification purposes, “num_likes” refers to the number of likes the post “p” has received, “num_of sharings” refers to the number of times that post “p” has been shared, and “num_non_negative_comments” refers to the number of non-negative comments that post “p” has received. For each community (or group) of users, post guideline program 110 computes statistics on the popularity of posts in the community, based on various properties of the post (e.g., length, language, embedding pictures, links to external resources, font type and size, etc.). The properties with linear values can be formatted into binary or normalized values to be able to create better statistics, for example: length: short, medium, and long. For a property “prop,” for each value “v” of prop, post guideline program 110 analyzes the average (or median) popularity of posts with prop==v. Post guideline program 110 can also calculate the same statistics for the combination of properties, based on normalized values described above.

In step 230, post guideline program 110 provides guidelines to a user of the social network. The guidelines are based on the statistics from the analyzed information. In some embodiments, the guidelines contain recommendation on the content format, for example, but not limited to: how long the post should be, whether the post contain images/video/hyperlinks, and a preferred language. For example, if there is a positive correlation between the length of a post and the popularity of the post, post guideline program 110 can suggest to the user to make the post longer, as opposed to a shorter post. As another example, if short posts with images are, on average, more popular, post guideline program 110 can suggest to the user to add an image to the post and to limit the length of the text of the post. While some guidelines are global, other guidelines are specific to the target groups of people (or communities), for example, posts written in English may be less popular in a community of German speaking users. In other embodiments, post guideline program 110 provides guidelines to the user of the social network, based on the popularity of the user's previous posts to the user's social network. In some embodiments, post guideline program 110 provides guidelines to the user of the social network, based on the popularity of posts to the community or group, in general. Still, in other embodiments, post guideline program 110 considers recent posts, based on a predetermined threshold time period (e.g., six months or one year), when calculating statistics, as the tastes of a group of people may change over time. Post guideline program 110 may consider only recent posts because, for example, the group of people within a community changes as people join the group or leave the group, and the preferences of existing members may change.

Embodiments of the present invention recognize that based on the user's style of writing posts, and knowing that the user may not be able to easily change writing styles, post guideline program 110 can recommend communities where the user's writing style would be well received. In such an embodiment, post guideline program 110 creates a profile for the user, based on the user's posts (length, language, etc.), and suggest to the user to write posts for the chosen audiences, whose format preferences fit the user's writing style. For example, a user is a member of two communities, A (Spanish language group) and B (English language group). When embodiments of the present invention recognize that the user usually writes short updates using pictures and links in a Spanish language, post guideline program 110 recommends the user to post an update in community A, where such updates are relatively more popular.

FIG. 3 depicts computer system 300, which is an example of a system that includes components of server 30, computing device 40, and/or social media server 50. Computer system 300 includes processors 301, cache 303, memory 302, persistent storage 305, communications unit 307, input/output (I/O) interface(s) 306 and communications fabric 304. Communications fabric 304 provides communications between cache 303, memory 302, persistent storage 305, communications unit 307, and input/output (I/O) interface(s) 306. Communications fabric 304 can be implemented with any architecture designed for passing data and/or control information between processors (such as microprocessors, communications and network processors, etc.), system memory, peripheral devices, and any other hardware components within a system. For example, communications fabric 304 can be implemented with one or more buses or a crossbar switch.

Memory 302 and persistent storage 305 are computer readable storage media. In this embodiment, memory 302 includes random access memory (RAM). In general, memory 302 can include any suitable volatile or non-volatile computer readable storage media. Cache 303 is a fast memory that enhances the performance of processors 301 by holding recently accessed data, and data near recently accessed data, from memory 302.

Program instructions and data used to practice embodiments of the present invention may be stored in persistent storage 305 and in memory 302 for execution by one or more of the respective processors 301 via cache 303. In an embodiment, persistent storage 305 includes a magnetic hard disk drive. Alternatively, or in addition to a magnetic hard disk drive, persistent storage 305 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 305 may also be removable. For example, a removable hard drive may be used for persistent storage 305. Other examples include optical and magnetic disks, thumb drives, and smart cards that are inserted into a drive for transfer onto another computer readable storage medium that is also part of persistent storage 305.

Communications unit 307, in these examples, provides for communications with other data processing systems or devices. In these examples, communications unit 307 includes one or more network interface cards. Communications unit 307 may provide communications through the use of either or both physical and wireless communications links. Program instructions and data used to practice embodiments of the present invention may be downloaded to persistent storage 305 through communications unit 307. Post guideline program 110 and database 120 may be downloaded to persistent storage 305 of server 30 through communications unit 307 of server 30. User interface 130 may be downloaded to persistent storage 305 of computing device 40 through communications unit 307 of computing device 40.

I/O interface(s) 306 allows for input and output of data with other devices that may be connected to each computer system. For example, I/O interface 306 may provide a connection to external devices 308 such as a keyboard, keypad, a touch screen, and/or some other suitable input device. External devices 308 can also include portable computer readable storage media such as, for example, thumb drives, portable optical or magnetic disks, and memory cards. Software and data used to practice embodiments of the present invention, e.g., post guideline program 110 and database 120, can be stored on such portable computer readable storage media and can be loaded onto persistent storage 305 of server 30 via I/O interface(s) 306 of server 30. Software and data used to practice embodiments of the present invention, e.g., user interface 130, can be stored on such portable computer readable storage media and can be loaded onto persistent storage 305 of computing device 40 via I/O interface(s) 306 of computing device 40. I/O interface(s) 306 also connect to display 309.

Display 309 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for providing guidelines to a user for content publishing in a social network, the method comprising:
receiving, by one or more processors, initialization of a composition of a new post to a first group of a social network, wherein the initialization is triggered when a user selects an option to create the composition of the new post;
retrieving, by one or more processors, information from the first group of the social network;
analyzing, by one or more processors, the information; and
upon the user beginning to compose the new post, providing, by one or more processors, a guideline based on the analysis, wherein the guideline includes at least one recommendation as to how to formulate the new post to increase positive reception of the new post.

2. The method of claim 1, wherein analyzing the information comprises:
analyzing, by one or more processors, the information by calculating an aggregation of positive actions that a previous post caused to the first group.

3. The method of claim 2, wherein the positive actions include one or more of:
likes, non-negative comments, and shares of the previous post with other users.

4. The method of claim 1, further comprising:
identifying, by one or more processors, trends in one or more previous posts of the user;
creating, by one or more processors, a profile for the user, based on the identified trends;
determining, by one or more processors, a second target group, wherein the second target group's format preferences coincide with the profile for the user; and
recommending, by one or more processors, to the user to write posts to the second target group.

5. The method of claim 1, wherein the information from the first group of the social network comprises recent posts to the first group of the social network, wherein the recent posts are gathered when a person joins the first group.

6. The method of claim 1, wherein the new post has properties that include one or more of: length, language, embedded pictures, embedded audio, embedded video, links to external resources, font type, and font size.

7. (canceled)

8. A computer program product for providing guidelines to a user for content publishing in a social network, the computer program product comprising:
a computer readable storage medium having program instructions embodied therewith, wherein the computer readable storage medium is not a transitory signal per se, the program instructions executable by one or more computer processors to cause the one or more computer processors to perform a method comprising:
receiving, by one or more processors, initialization of a composition of a new post to a first group of a social network, wherein the initialization is triggered when a user selects an option to create the composition of the new post;
retrieving, by one or more processors, information from the first group of the social network;
analyzing, by one or more processors, the information; and
upon the user beginning to compose the new post, providing, by one or more processors, a guideline based on the analysis, wherein the guideline includes at least one recommendation as to how to formulate the new post to increase positive reception of the new post.

9. The computer program product of claim 8, wherein analyzing the information comprises:
analyzing, by one or more processors, the information by calculating an aggregation of positive actions that a previous post caused to the first group.

10. The computer program product of claim 9, wherein the positive actions include one or more of: likes, non-negative comments, and shares of the previous post with other users.

11. The computer program product of claim 8, further comprising:
identifying, by one or more processors, trends in one or more previous posts of the user;
creating, by one or more processors, a profile for the user, based on the identified trends;
determining, by one or more processors, a second target group, wherein the second target group's format preferences coincide with the profile for the user; and
recommending, by one or more processors, to the user to write posts to the second target group.

12. The computer program product of claim 8, wherein the information from the first group of the social network comprises recent posts to the first group of the social network, wherein the recent posts are gathered when a person joins the first group.

13. The computer program product of claim 8, wherein the new post has properties that include one or more of: length, language, embedded pictures, embedded audio, embedded video, links to external resources, font type, and font size.

14. (canceled)

15. A computer system for providing guidelines to a user for content publishing in a social network, the computer system comprising:
one or more computer processors, one or more computer readable storage media, and program instructions stored on the computer readable storage media for execution by at least one of the one or more processors, the program instructions comprising:
program instructions to receive initialization of a composition of a new post to a first group of a social network, wherein the initialization is triggered when a user selects an option to create the composition of the new post;
program instructions to retrieve information from the first group of the social network;
program instructions to analyze the information; and
upon the user beginning to compose the new post, program instructions to provide a guideline based on the analysis, wherein the guideline includes at least one recommendation as to how to formulate the new post to increase positive reception of the new post.

16. The computer system of claim 15, wherein program instructions to analyze the information comprise:
program instructions to analyze the information by calculating an aggregation of positive actions that a previous post caused to the first group.

17. The computer system of claim 16, wherein the positive actions include one or more of: likes, non-negative comments, and shares of the previous post with other users.

18. The computer system of claim 15, further comprising:
program instructions, stored on the computer readable storage media for execution by at least one of the one or more processors, to identify trends in one or more previous posts of the user;
program instructions, stored on the computer readable storage media for execution by at least one of the one or more processors, to create a profile for the user, based on the identified trends;
program instructions, stored on the computer readable storage media for execution by at least one of the one or more processors, to determine a second target group, wherein the second target group's format preferences coincide with the profile for the user; and
program instructions, stored on the computer readable storage media for execution by at least one of the one or more processors, to recommend to the user to write posts to the second target group.

19. The computer system of claim 15, wherein the information from the first group of the social network comprises recent posts to the first group of the social network, wherein the recent posts are gathered when a person joins the first group.

20. The computer system of claim 15, wherein the post has properties that include one or more of: length, language, embedded pictures, embedded audio, embedded video, links to external resources, font type, and font size.

21. (canceled)

22. The method of claim 1, wherein the information is retrieved from: a social media profile for the user, a recent search on a general search engine, a recent search on an internal search engine, a social media post, a database, and a monitored social media network.

23. The method of claim 6, wherein the properties with linear values are formatted into normalized values to calculate statistics on a popularity of the post for a combination of the properties.
